(19) United States
(12) Patent Application Publication
(10) Pub. No.: US 2005/0006303 A1
(43) Pub. Date: Jan. 13, 2005

(54) Atmospheric plasma treatment of meltblown fibers used in filtration

(76) Inventor: Robert G. Sanders, Rochester, NH (US)

Correspondence Address: BIRCH STEWART KOLASCH & BIRCH, PO BOX 747, FALLS CHURCH, VA, 22040-0747, US

(21) Appl. No.: 10/822,747

(22) Filed: Apr. 13, 2004

Related U.S. Application Data
(60) Provisional application No. 60/486,197, filed on Jul. 11, 2003.

(51) Int. Cl. B01D 39/02

(52) U.S. Cl. 210/504; 210/505; 210/508

(57) ABSTRACT

An improvement in filtration is seen by treating microfibers with a gaseous plasma at atmospheric conditions. The improvement results from etching the microfibers thereby increasing the surface area of the microfibers.

### BACKGROUND OF THE INVENTION

1. Field of the Invention

The instant invention relates to a fibrous filter media comprising a web of thermoplastic fibers, wherein said thermoplastic fibers have been surface modified with a gaseous plasma at atmospheric conditions. The instant invention also relates to methods to generate said fibrous filter media.

2. Description of Related Art

The filtration properties of nonwoven polymeric fibrous webs can be improved by transforming the web into an electret, i.e., a dielectric material exhibiting a quasi-permanent electrical charge. The electrostatic charge provides for increased filter efficiency against a variety of substances, especially charged particulates such as dust. Electrets are effective in enhancing particle capture in aerosol filters. Electrets are useful in a variety of devices including, e.g., air filters, face masks, and respirators, and as electrostatic elements in electro-acoustic devices such as microphones, headphones, and electrostatic recorders. Charged filters are commonly used today in household heating and air conditioning filters, in vacuum bags, and for other uses.

Filtration webs can be formed by a variety of methods. For example, a thin film or monolayer of polymer material can be extruded and charged via corona discharge. The charged film is then fibrillated and the resulting fibrils formed into a non-woven web via needle punching or other known means. In another method, a polymer is melt blown as a fine fiber and then fashioned into a non-woven web. The fibers are charged either as they exit the orifice of the extruder during melt blowing or after they are assembled into a web. Charging can be carried out by corona exposure, ion bombardment, etc. Electrets are currently produced by a variety of methods including direct current (“DC”) corona charging (see, e.g., U.S. Pat. Re. 30,782 (van Turnhout)), and hydrocharging (see, e.g., U.S. Pat. No. 5,496,507 (Angadjivand et al.)), and can be improved by incorporating fluorochemicals into the melt used to produce the fibers of some electrets (see, e.g., U.S. Pat. No. 5,025,052 (Crater et al.)).

Many of the particles and contaminants with which electret filters come into contact interfere with the filtering capabilities of the webs. Liquid aerosols, for example, particularly oily aerosols, tend to cause electret filters to lose their electret enhanced filtering efficiency (see, e.g., U.S. Pat. No. 5,411,576 (Jones et al.)).

Numerous methods have been developed to compensate for loss of filtering efficiency. One method includes increasing the amount of the nonwoven polymeric web in the electret filter by adding layers of webs or increasing the thickness of the electret filter. The additional web, however, increases the breathing resistance of the electret filter, adds weight and bulk to the electret filter, and increases the cost of the electret filter. Another method for improving an electret filter's resistance to oily aerosols includes forming the electret filter from resins that include melt processable fluorochemical additives such as fluorochemical oxazolidinones, fluorochemical piperazines, and perfluorinated alkanes. (See, e.g., U.S. Pat. No. 5,025,052 (Crater et al.)). The fluorochemicals should be melt processable, i.e., suffer substantially no degradation under the melt processing conditions used to form the microfibers that are used in the fibrous webs of some electrets. (See, e.g., WO 97/07272 (Minnesota Mining and Manufacturing)). U.S. Pat. No. 6,419,871 (Ogale) discloses an electrostatic filter medium comprising a web of electret fibers which have been treated with fluorine-containing plasmas to produce fibers that are electrostatically charged. The fibers in U.S. Pat. No. 6,419,871 are subsequently rinsed and dried. However, U.S. Pat. No. 6,419,871 suffers from the drawbacks of having to use a chamber at reduced pressure wherein the pressure used is on the order of 1×10⁻² to 1.0 Torr. Because the plasma treatment is performed at reduced pressure (also called vacuum plasma treatment), one is limited by the size of the chamber that can be used. U.S. Pat. No. 6,419,871 is herein incorporated by reference in its entirety.

The inventor of the instant invention has found that he is able to address some of these drawbacks. Thus, the instant invention discloses improvements that further enhance the filtration properties of polymeric fibrous webs and electrolets.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE SEVERAL VIEWS OF THE DRAWINGS

The present invention will become more fully understood from the detailed description given hereinbelow and the accompanying drawings which are given by way of illustration only, and thus are not limitative of the present invention, and wherein:

FIG. 1 is a 2500 fold magnification of 1 micron poly(butylene-terephthalate) fibers;

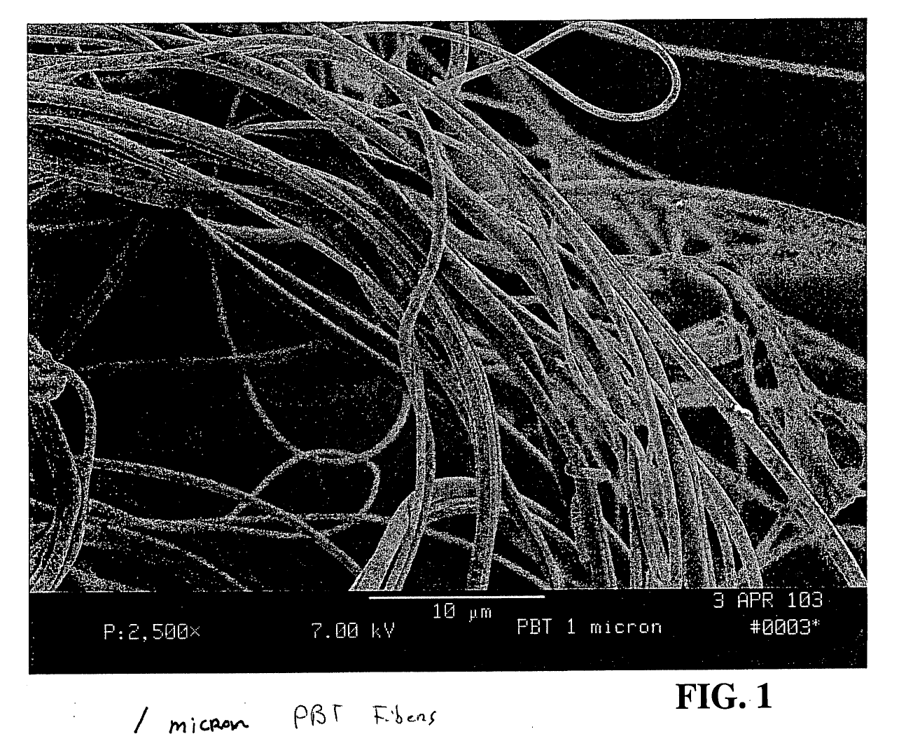

FIG. 2 is a 500 fold magnification of 1 micron poly(butylene-terephthalate) fibers;

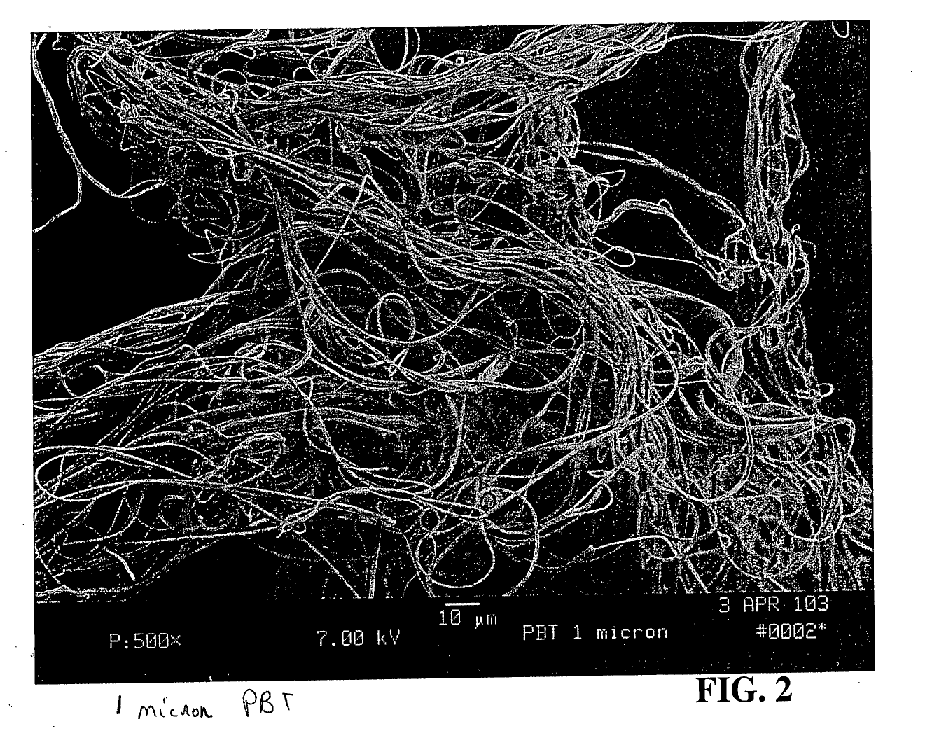

FIG. 3 is a 10,000 fold magnification of 1 micron poly(butylene-terephthalate) fibers;

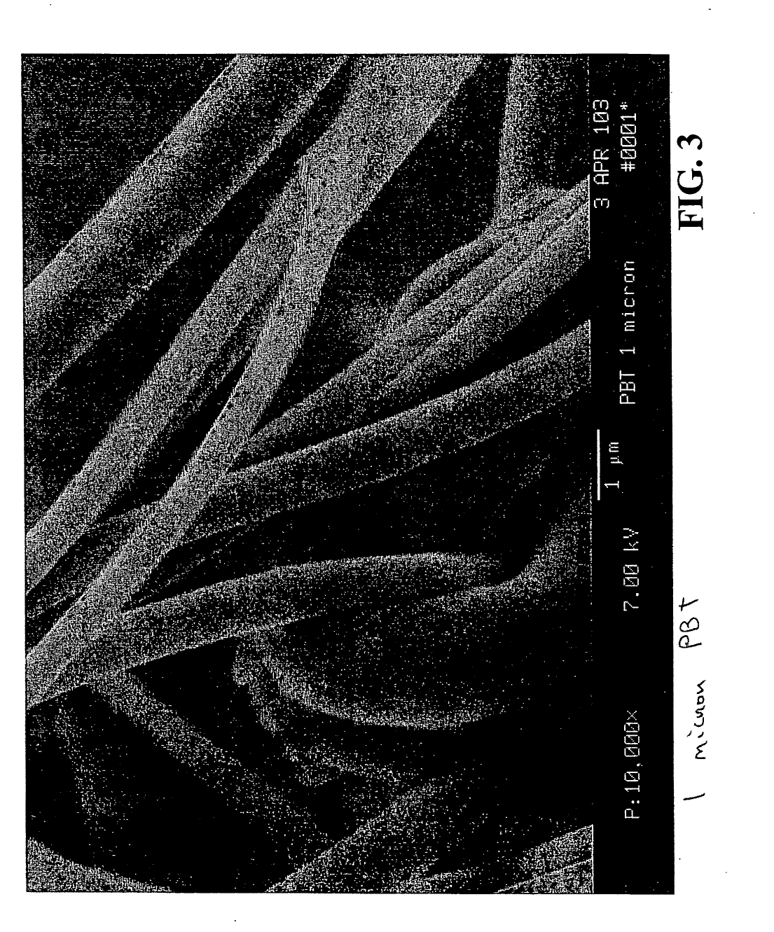

FIG. 4 is a 50,000 fold magnification of untreated polypropylene fibers;

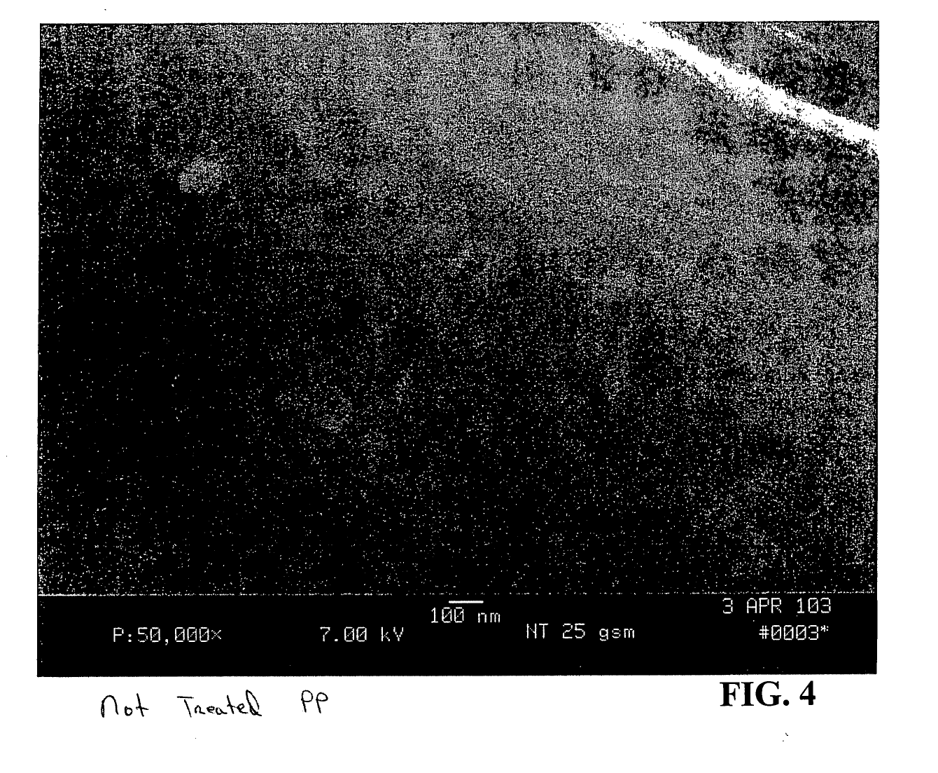

FIG. 5 is a 30,000 fold magnification of untreated polypropylene fibers;

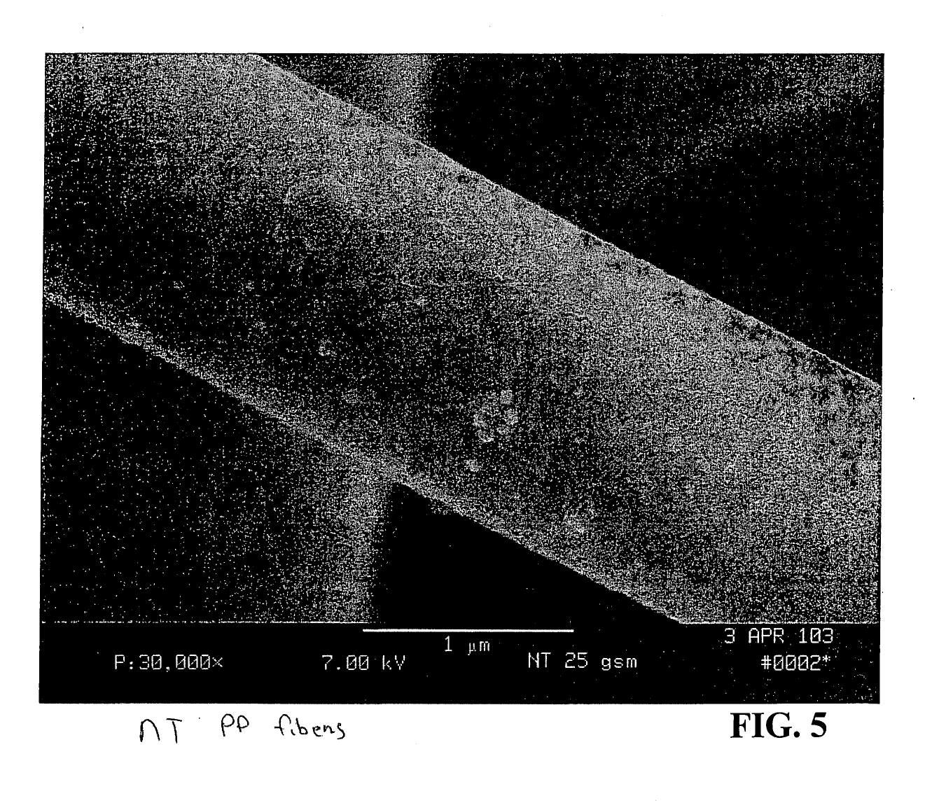

FIG. 6 is a 10,000 fold magnification of 1 micron poly(butylene-terephthalate) fibers;

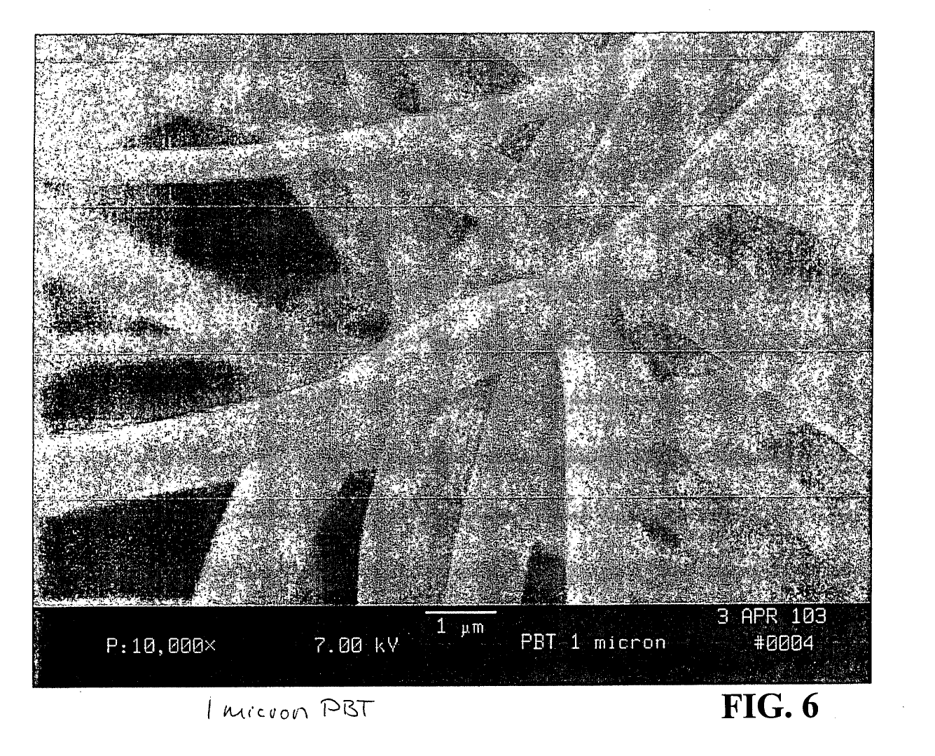

FIG. 7 is a 2,500 fold magnification of untreated polypropylene fibers;

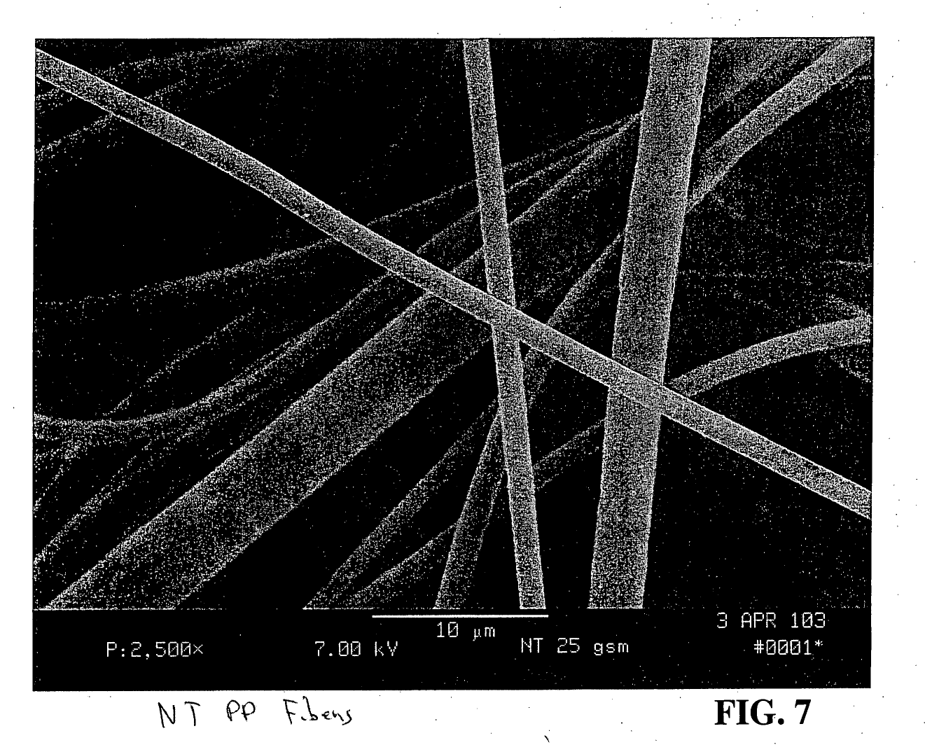

FIG. 8 is a 50,000 fold magnification of atmospheric plasma treated fibers;

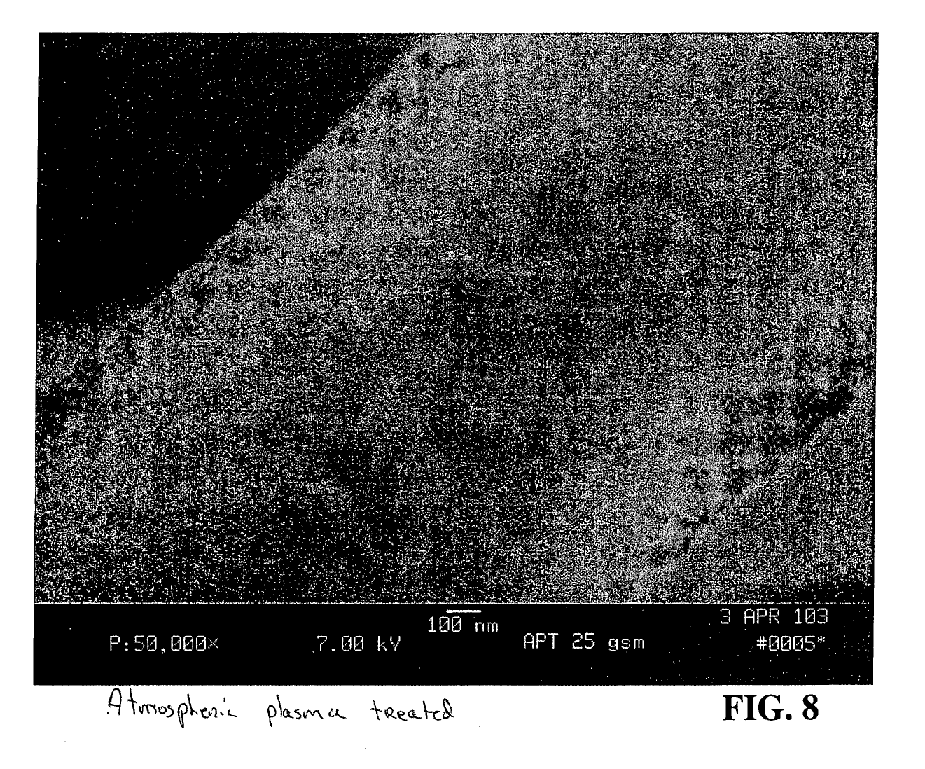

FIG. 9 is a 30,000 fold magnification of atmospheric plasma treated fibers;

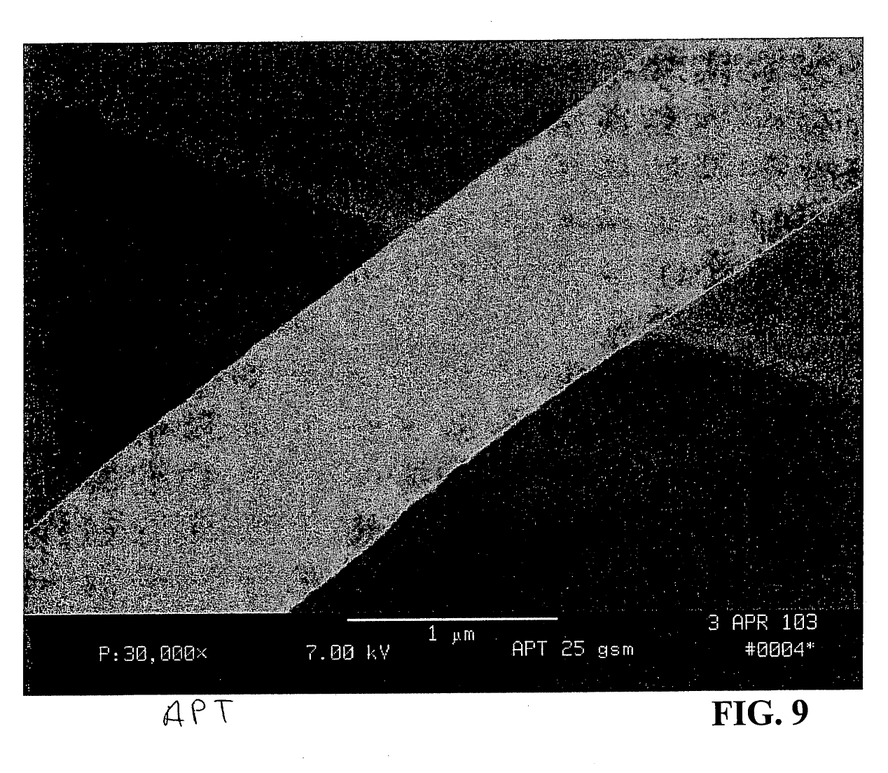

FIG. 10 is a 10,000 fold magnification of atmospheric plasma treated fibers;

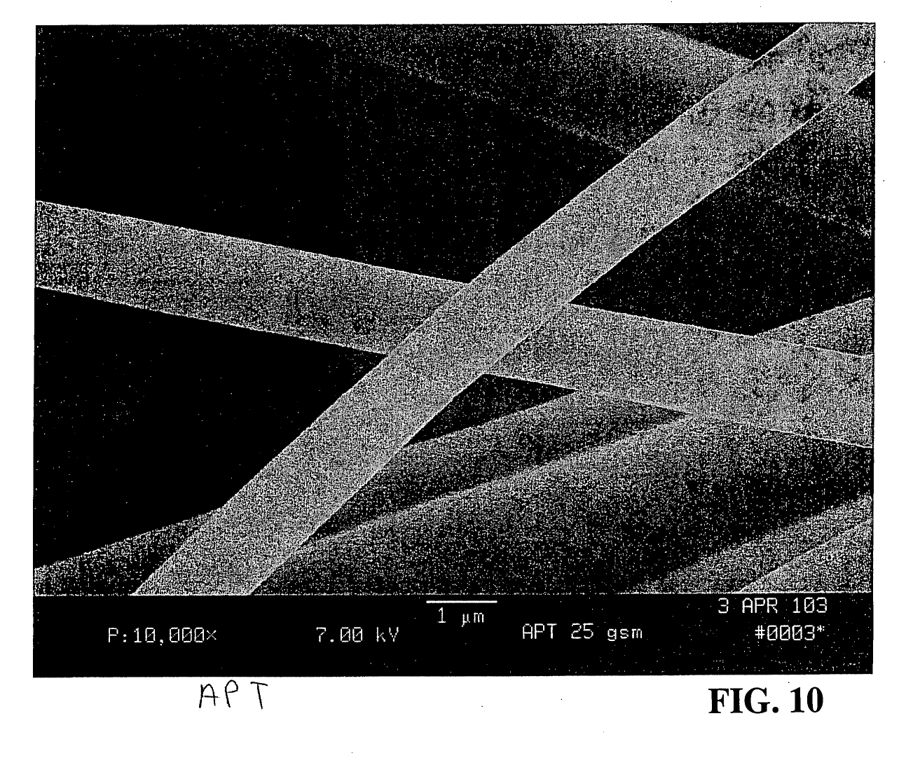

FIG. 11 is a 5,050 fold magnification of atmospheric plasma treated fibers;

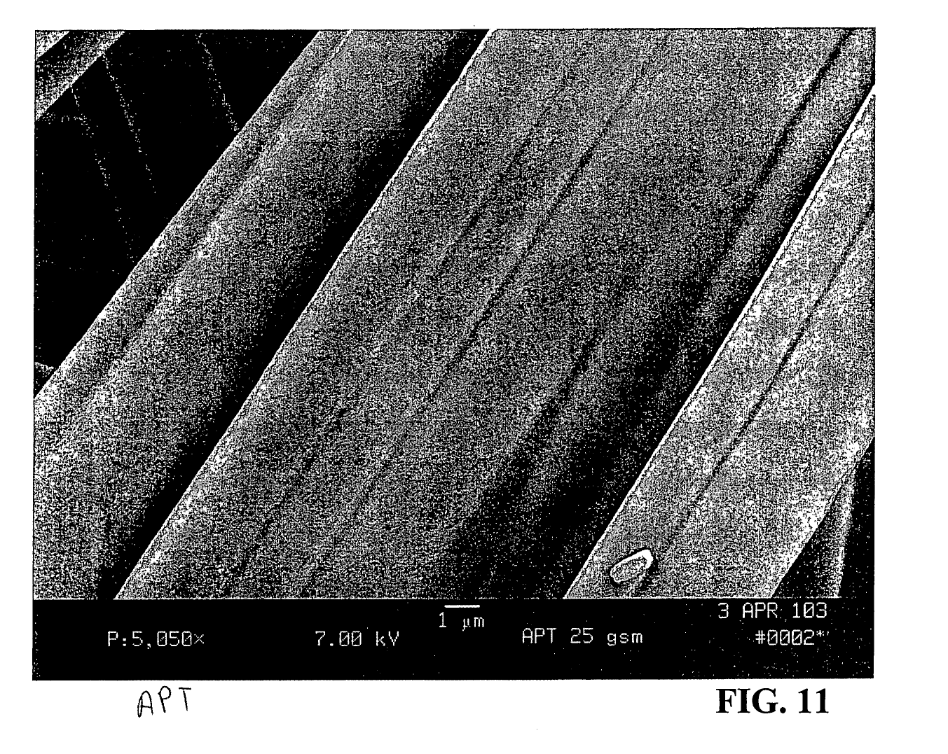

FIG. 12 is a 2,500 fold magnification of atmospheric plasma treated fibers; and

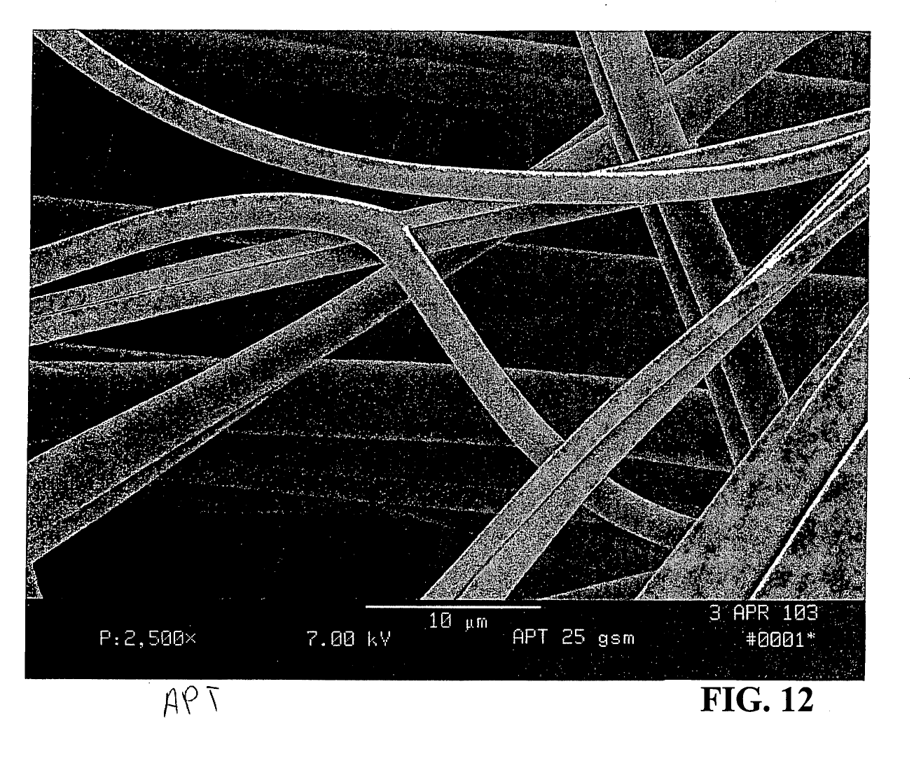

FIG. 13 provides a comparison of the % Efficiency between the raw material, plasma treated material, plasma treated material that is also charged, plasma treated material that has been soaked in isopropyl alcohol, and plasma treated material that is charged and also soaked in isopropyl alcohol.

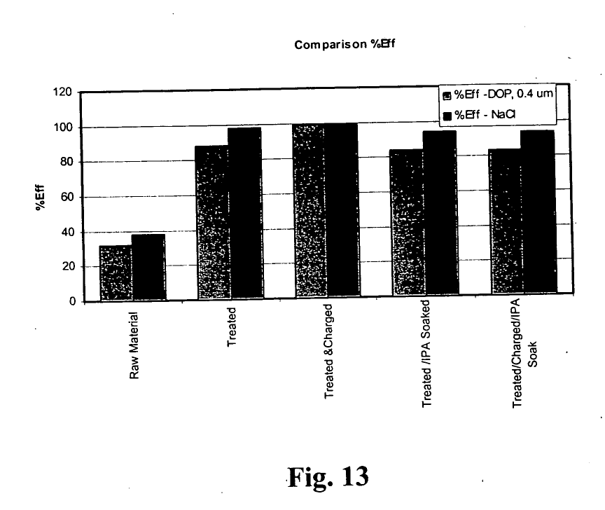

### DETAILED DESCRIPTION OF THE INVENTION

The present inventor has found that by modifying the surface of microfibers by surface treatment with an atmospheric plasma process, improved filtration occurs. Moreover, the use of atmospheric plasma conditions means that a reduced pressure chamber is not required for plasma treatment leading to decreased costs and the ability to treat greater amounts of microfibers. Atmospheric plasma treatment has an advantage over corona treated surfaces in that atmospheric plasma treated surfaces hold their treatment longer. The atmospheric plasma treating process also allows the treatment of microfibers without being restricted by both the size of chambers and the reduced pressure needed in reduced pressure plasma treatment equipment.

Atmospheric plasma treatment of microfibers likely leads to improved filtration ability due to one or more of the following: etching the surface, the cleaning of the surface, deposition of chemicals, oxidation or reduction of the surface, or the efficient formation of free radicals on the surface generating the possibility of intermolecular cross-linking (carbonization).

In the etching process, it is likely that the etching exposes internally melted additives such as activated carbon, colorants, and other possible additives that further aid in filtration. The increased surface area can enhance filtration properties by post charging of the media through conventional electret charging equipment.

As an alternative mechanism, it is likely that cleaning the surface removes oily residues from the surface of the microfibers allowing better filtration by exposing the surface to the particles to be filtered.

The process may also increase the amount of additives from the interior at the surface of these microfibers. Additionally or alternatively, the instant invention allows more surface area exposed per weight than does previously disclosed methods, all of which improves the filtration process.

Irrespective of the mechanism, the net result of the instant invention is that there is an increased surface area of the fibers available for filtration allowing more “sights” or area for particle entrapment, thus, leading to a more effective filter.

The instant invention also does not require the higher ratio of additives of previous methods yet it is still effective at filtering the desired particles, Thus, the instant method has decreased costs. Further, the higher ratio of additives used in the prior art experienced problems associated with fiber processing that could not be overcome by machine adjustments. Because the instant method does not require a higher ratio of additives it does not suffer from the problems encountered in fiber processing.

Further, currently available equipment to make meltblown fibers have physical limitations that prevent the manufacture of fibers that are consistently less than 1 micron in size. Because the instant method provides a microfiber that has improved filtration ability, there is less reliance on manufacturing fibers that are all uniformly small in size.

Accordingly, the instant invention has a fibrous filter media comprising a web of thermoplastic fibers. It should be understood that these thermoplastic fibers can be made of any known thermoplastic material, however preferred materials include polyolefins, polyesters, polycarbonates, polyimides, and polyamides, or mixtures of any of these materials. Although all of the above materials can be used, preferred materials include polyesters and polyolefins, such as poly(butylene-terephthalate) and polypropylene. Additionally, thermoplastic copolymers also can be used with the preferred copolymers being combinations of any of the above mentioned materials.

By a web with “enhanced particulate filtration properties” it is meant that the web of the instant invention filters better than a web that is not treated by the gaseous plasma at atmospheric conditions of the instant invention. Generally, the web of the instant invention has an ability to filter that is at least 1 1/2 times superior to that of the untreated web, preferably at least 2 times superior to that of the untreated web, more preferably at least 3 times superior to that of the untreated web, more preferably at least 4 times superior to that of the untreated web, and most preferably at least 5 times superior to that of the untreated web. In particular, the instant invention shows the above mentioned “enhanced particulate filtration properties” regarding being able to filter any of a number of particles such as dust, fungi, antigens, molds, other small particles, etc. or any of a number of chemical compounds such as any of a number of salts, (for example, NaCl).

In particular, the instant invention relates to a fibrous filter media comprising a web of thermoplastic fibers, wherein said thermoplastic fibers have been surface modified with a gaseous plasma at atmospheric conditions. By atmospheric conditions, it is meant that no vacuum pumps or other devices that produce reduced pressure are needed in the plasma treatment.

In another embodiment, the instant invention is directed to a method of generating a fibrous filter media with enhanced particulate filtration efficiency wherein said method comprises treating a web of thermoplastic fibers with a gaseous plasma at atmospheric conditions. The gaseous plasma treatment is done under atmospheric conditions that are adapted for surface modifying the thermoplastic fibers.

In both the fibrous filter media and the method of generating the fibrous filter media, the following conditions can be used before during or after plasma treatment.

After or before gaseous plasma treatment, the thermoplastic fibers can be electrostatically charged. Electrostatic charging of the thermoplastic fibers can be performed by any means that is known in the art with a corona discharge method being particularly preferred.

In one embodiment of the invention, the gaseous plasma treatment increases the surface area of the thermoplastic fibers relative to the case where the same or similar thermoplastic fibers do not undergo gaseous plasma treatment.

Preferred means of employing a gaseous plasma treatment on the thermoplastic fibers includes but is not limited to inert gas treatment independently or combined with air, with preferred gas combinations being He/air, Ar/air, Ne/air, Xe/air, N₂/air, Kr/air, or any combination/mixture of these gas combinations, with the more preferred combination being Ar/air and/or He/air.

Any of the above gas combinations can be combined with a treatment with fluorine-containing plasmas to produce fibers that are electrostatically charged to generate fibers that possess improved charge stability.

In one embodiment of the instant invention, the web is a fibrous layer of melt extruded fibers or filaments. Alternatively, the web can be comprised of carded, airlaid, or wetlaid staple fibers or any combination of these or any combination that also includes melt extruded fibers. In a preferred embodiment meltblown fibers are used.

In another embodiment of the invention, a gradient of a fibrous filter media can be applied wherein fibers that are upstream are treated by a different method than fibers that are downstream, thus generating a fibrous filter media that possesses a gradient of filtering ability. It will be evident to those of skill in the art that the upstream fibers can possess either superior or inferior filtration ability to those fibers that are downstream. Any of the above-described processes can be added or omitted to this fibrous filter media to generate the aforementioned gradient.

### EXAMPLES

Tables 1-6 illustrate the NaCl penetration of both plasma treated and control fibrous filter media.

Test Data For Treated And Control Heat Tested In
Oven At 150^{F}

| | Control | | Plasma Treated | |
|---|---|---|---|---|
| | NaCl | NaCl | NaCl | NaCl |
| | Penetration @ | Resistance | Penetration @ | Resistance @ |
| | 32LPM | @ 32LPM | 32LPM | 32LPM |
| 1 | 9.55 | 2.0 | 1.25 | 4.4 |
| 1A | 10.2 | 2.0 | 1.63 | 4.2 |
| 2 | 12.8 | 1.8 | 3.36 | 3.2 |
| 2A | 11.1 | 1.9 | 2.42 | 3.7 |
| 3 | 10.4 | 1.8 | 4.87 | 2.8 |
| 3A | 14.4 | 1.7 | 9.57 | 2.8 |
| 4 | 32.8 | 2.2 | 1.76 | 3.9 |
| 4A | 10.8 | 2.0 | 2.46 | 3.4 |
| Average | 14.01 | 1.9 | 3.42 | 3.6 |
| % | | | | |
| Efficiency | 86 | | 96.6 | |

Retested after 14 hours in oven at 150^{F}

| | Control | | Plasma Treated | |
|---|---|---|---|---|
| | NaCl | NaCl | NaCl | NaCl |
| | Penetration @ | Resistance | Penetration @ | Resistance @ |
| | 32LPM | @ 32LPM | 32LPM | 32LPM |
| 1 | 27.8 | 1.9 | 6.91 | 3.7 |
| 1A | 28.3 | 1.9 | 7.63 | 3.4 |
| 2 | 28.2 | 1.8 | 11.6 | 2.7 |
| 2A | 28.3 | 1.9 | 9.14 | 3.1 |
| 3 | 22.5 | 1.8 | 11.5 | 2.4 |
| 3A | 27.6 | 1.7 | 16.6 | 2.4 |
| 4 | 40.5 | 2.1 | 9.33 | 3.2 |
| 4A | 24.9 | 1.9 | 11.7 | 2.7 |
| Average | 28.5 | 1.9 | 10.6 | 3.0 |
| % | | | | |
| Efficiency | 71.5 | | 89.4 | |

TABLES 1-6
Retested after 4 days and 14 hours in oven at 150^{F}

| | Control | | Plasma Treated | |
|---|---|---|---|---|
| | NaCl | NaCl | NaCl | NaCl |
| | Penetration @ | Resistance | Penetration @ | Resistance @ |
| | 32LPM | @ 32LPM | 32LPM | 32LPM |
| 1 | 32.8 | 1.9 | 8.84 | 3.6 |
| 1A | 31.6 | 1.8 | 9.95 | 3.4 |
| 2 | 32.5 | 1.8 | 13.7 | 2.7 |
| 2A | 31.5 | 1.9 | 10.7 | 3.1 |
| 3 | 25.6 | 1.8 | 13.2 | 2.3 |
| 3A | 30.0 | 1.6 | 16.5 | 2.3 |
| 4 | 40.5 | 2.1 | 11.5 | 3.1 |
| 4A | 26.7 | 1.9 | 14.8 | 2.7 |
| Average | 31.4 | 1.9 | 12.4 | 2.9 |
| % | | | | |
| Efficiency | 68.6 | | 87.6 | |

It will be understood by those of skill in the art that the scope of the instant invention includes any combination of the features disclosed in this invention.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A fibrous filter media comprising a web of thermoplastic fibers, wherein said thermoplastic fibers have been surface modified with a gaseous plasma at atmospheric conditions.

2. The fibrous filter media of claim 1, wherein the thermoplastic fibers are electrostatically charged.

3. The fibrous filter media according to claim 2, wherein the electrostatically charged thermoplastic fibers are electrostatically charged by a corona discharge method.

4. The fibrous filter media according to claim 1, wherein said gaseous plasma is a He/air mixture.

5. The fibrous filter media according to claim 2, wherein said gaseous plasma is a He/air mixture.

6. The fibrous filter media according to claim 3, wherein said gaseous plasma is a He/air mixture.

7. The fibrous filter media according to claim 1, wherein said gaseous plasma is an Ar/air mixture.

8. The fibrous filter media according to claim 2, wherein said gaseous plasma is an Ar/air mixture.

9. The fibrous filter media according to claim 3, wherein said gaseous plasma is an Ar/air mixture.

10. The fibrous filter media according to claim 1, wherein said thermoplastic fibers are made from one or more of the members selected from the group consisting of polyolefins, polyesters, polycarbonates, polyimides, and polyamides.

11. The fibrous filter media according to claim 2, wherein said thermoplastic fibers are made from one or more of the members selected from the group consisting of polyolefins, polyesters, polycarbonates, polyimides, and polyamides.

12. The fibrous filter media according to claim 3, wherein said thermoplastic fibers are made from one or more of the members selected from the group consisting of polyolefins, polyesters, polycarbonates, polyimides, and polyamides.

13. The fibrous filter media according to claim 1, wherein the web is a fibrous layer of melt extruded fibers or filaments.

14. The fibrous filter media according to claim 2, wherein the web is a fibrous layer of melt extruded fibers or filaments.

15. The fibrous filter media according to claim 3, wherein the web is a fibrous layer of melt extruded fibers or filaments.

16. The fibrous filter media according to claim 1, wherein the web possesses enhanced particulate filtration properties.

17. The fibrous filter media according to claim 2, wherein the web possesses enhanced particulate filtration properties.

18. The fibrous filter media according to claim 3, wherein the web possesses enhanced particulate filtration properties.

19. The fibrous filter media according to claim 1, wherein the web is comprised of carded, airlaid, or wetlaid staple fibers.

20. The fibrous filter media according to claim 2, wherein the web is comprised of carded, airlaid, or wetlaid staple fibers.

21. The fibrous filter media according to claim 3, wherein the web is comprised of carded, airlaid, or wetlaid staple fibers.

22. The fibrous filter media according to claim 1, wherein the web is constructed using a fibrous layer of melt extruded fibers or filaments and any one or more of carded, airlaid, or wetlaid staple fibers.

23. The fibrous filter media according to claim 2, wherein the web is constructed using a fibrous layer of melt extruded fibers or filaments and any one or more of carded, airlaid, or wetlaid staple fibers.

24. The fibrous filter media according to claim 3, wherein the web is constructed using a fibrous layer of melt extruded fibers or filaments and any one or more of carded, airlaid, or wetlaid staple fibers.

25. A fibrous electret filter media with improved charge stability to environmental conditions comprising a web of thermoplastic fibers which have been surface modified with a gaseous plasma at atmospheric conditions and charged.

26. The fibrous electret filter media according to claim 28, wherein the fibrous electret filter media is charged by corona discharge.

27. A fibrous electret filter media with improved charge stability to thermal conditions comprising a web of thermoplastic fibers which have been surface modified with a gaseous plasma at atmospheric conditions and charged.

28. The fibrous electret filter media according to claim 27, wherein the fibrous electret filter media is charged by corona discharge.

29. A method of generating a fibrous filter media comprising providing a web of thermoplastic fibers, surface modifying said thermoplastic fibers with a gaseous plasma at atmospheric conditions to generate the fibrous filter media.

30. The method claim 29 wherein the thermoplastic fibers are made of a polymer selected from the group consisting of polyolefins, polyesters, polycarbonates, polyimides, and polyamides.

31. The method of claim 29 wherein said gaseous plasma is a He/air mixture.

32. The method of claim 29 wherein said gaseous plasma is an Ar/air mixture.

33. The method of claim 29 wherein the web is comprised of carded, airlaid, or wetlaid staple fibers.
